(19) United States
(12) Patent Application Publication
(10) Pub. No.: US 2016/0016144 A1
(43) Pub. Date: Jan. 21, 2016

(54) Control of Feedstock During Gas Production

(71) Applicant: MAGNEGAS CORPORATION, Tarpon Springs, FL (US)

(72) Inventor: Ermanno Santilli, Clearwater, FL (US)

(21) Appl. No.: 14/802,450

(22) Filed: Jul. 17, 2015

Related U.S. Application Data
(60) Provisional application No. 62/026,096, filed on Jul. 18, 2014.

(51) Int. Cl. B01J 19/08; C01B 3/04; C01B 3/22

(52) U.S. Cl. CPC B01J 19/088; C01B 3/22; C01B 3/04; B01J 2219/0894; B01J 2219/0809; B01J 2219/0877; C01B 2203/0272

(57) ABSTRACT

A system for producing a gas includes a pressure vessel containing in its interior a feedstock and at least one set of electrodes in which an electric arc is formed between the electrodes. The system includes a mechanism for passing of the feedstock through a plasma of the electric arc thereby converting at least some of the feedstock into a gas. The system has a way to controlling the electric arc by, for example, a controller adjusting the position of the electrodes of the arc and/or voltage applied to those electrodes. The system collects the gas and during the production of the gas, the system measures at least one of a conductance of the feedstock and a viscosity of the feedstock and, based on this/these measurements, the system introduces a material into the pressure vessel such as fresh feedstock, a solvent, tap water, distilled water, etc.

### CROSS-REFERENCE TO RELATED APPLICATION

This application claims the benefit of U.S. provisional application No. 62/026,096 filed on Jul. 18, 2014, the disclosure of which is incorporated by reference.

### FIELD

This invention relates to the field of gas production and more particularly to a system, method and apparatus for controlling the feedstock during production of a gas here within referred to as Magnegas.

### BACKGROUND

It has been demonstrated that, by exposing and/or flowing certain fluids through the plasma of a submerged electric arc, a unique gas is produced. The composition of the produced gas is dependent upon the feedstock in use, but the family of gases produced by exposing and/or flowing certain fluids through the plasma of an electric arc are herein referred to as Magnegas®. Various types and sources of feedstock have been used to produce Magnegas®. The resulting gas burns clean and at higher temperatures than gases occurring in nature or gases produced in different ways.

In general, the feedstock is presented into a reaction chamber, in which a submerged electric arc is formed. As the feedstock is exposed to the arc, the arc releases gases from the feedstock which are captured and stored for future uses.

In various systems, different methods have been anticipated to form the arc, control the electrodes, replenish/replacing the electrodes, capture the gas, capture heat produced, etc. Examples of fully operational systems for the production of Magnegas® can be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

In many of the systems for generation of Magnegas®, the reactor (or chamber) is filled with the feedstock and then the feedstock if pumped into and/or around the plasma of the arc, producing the gas which is then collected. As time goes by, as portions of the feedstock change into gas, dissolved and/or suspended particles within the feedstock change the properties of the feedstock. For example, consider flowing salt water through such an arc over a period of time. As the water (H₂O) is transformed into hydrogen (H) and Oxygen (O₂), the salt content of the remaining salt water increases. If such a process is allowed to continue, eventually the only material left in the reactor will be salt, though before that point, a very viscous liquid containing small amounts of water and large amounts of salts will be present.

Likewise, in examples where the feedstock is, for example, used vegetable oils (e.g. oils previously used to cook food), as the vegetable oils transform into a gas, dissolved and/or suspended particles within the feedstock remain, again changing the properties of the feedstock such as increasing the viscosity of the feedstock and/or changing the electrical conductance of the feedstock.

What is needed is a way to determine the instantaneous properties of the feedstock and introduce materials into the reactor to mitigate such changes to the properties.

### SUMMARY

A system for producing a gas including a pressure vessel containing in its interior a feedstock and at least one set of electrodes in which an electric arc is formed between the electrodes. The system includes a mechanism for passing of the feedstock through a plasma of the electric arc thereby converting at least some of the feedstock into a gas (e.g., a circulation system). The system has a way to controlling the electric arc by, for example, a controller adjusting the position of the electrodes of the arc and/or voltage applied to those electrodes. The system collects the gas (e.g. moves the gas to a storage tank). During the production of the gas, the system measures at least one of a conductance of the feedstock and a viscosity of the feedstock and, based on this/these measurements, the system introduces a material into the pressure vessel such as fresh feedstock, a solvent, tap water, distilled water, etc.

In one embodiment, a system for producing a gas is disclosed. The system includes a pressure vessel containing in its interior a feedstock and at least one set of electrodes and an electric arc formed between the electrodes and within the feedstock. A device flows of the feedstock through a plasma of the electric arc thereby converting at least some of the feedstock into the gas. There is a mechanism for controlling the electric arc and a mechanism for collecting the gas. A mechanism measures at least one of a conductance of the feedstock and a viscosity of the feedstock and based upon the conductance of the feedstock and/or the viscosity of the feedstock, the mechanism introduces an amount of a material into the pressure vessel.

In another embodiment, a system for producing a gas is disclosed. The system includes a pressure vessel containing in its interior a feedstock and at least one set of electrodes with a power supply electrically interfaced to the at least one set of electrodes such that an electric arc is formed between the electrodes. The electric arc is submerged within the feedstock. A circulation pump circulates the feedstock through a plasma of the electric arc where at least some of the feedstock is converted into the gas. A controller is interfaced to the power supply and controls an amount of the current provided to the electric arc. The controller also determines a viscosity of the feedstock by measuring a load on a motor driving the circulation pump and introduces a material into the pressure vessel based upon the viscosity of the feedstock.

In another embodiment, a method for producing a gas is disclosed. The method includes containing a feedstock in a pressure vessel that has a set of electrodes submerged in the feedstock and controlling power that is interfaced to the electrodes, thereby forming an electric arc between the electrodes. The electric arc is also submerged within the feedstock. The feedstock is circulated through a plasma of the electric arc, thereby converting at least some of the feedstock into the gas. A viscosity of the feedstock is determined and a material is introduced into the pressure vessel based upon the viscosity of the feedstock.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of an exemplary system for producing gas.

FIG. 2 illustrates a second schematic view of the exemplary system for producing gas.

FIG. 3 illustrates a third schematic view of the exemplary system for producing gas.

FIG. 4 illustrates a fourth schematic view of the exemplary system for producing gas.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

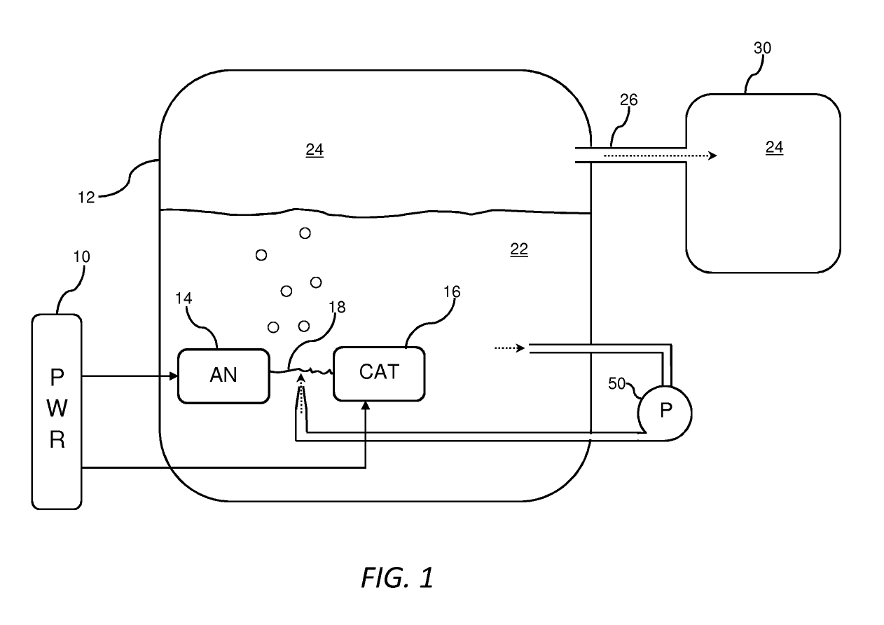

Referring to FIG. 1, an exemplary system for the production of a combustible gas, which is typically in gaseous form as produced, but often compressed, at times, in to a liquid. This is but an example of one system for the production of such a gas, as other such systems are also anticipated. Examples of fully operational systems for the production of a gas using a submerged arc are be found in U.S. Pat. No. 7,780,924 issued Aug. 24, 2010, U.S. Pat. No. 6,183,604 issued Feb. 6, 2001, U.S. Pat. No. 6,540,966 issued Apr. 1, 2003, U.S. Pat. No. 6,972,118 issued Dec. 6, 2005, U.S. Pat. No. 6,673,322 issued Jan. 6, 2004, U.S. Pat. No. 6,663,752 issued Dec. 16, 2003, U.S. Pat. No. 6,926,872 issued Aug. 9, 2005, and U.S. Pat. No. 8,236,150 issued Aug. 7, 2012, all of which are incorporated by reference.

As exemplified in FIGS. 1-4, the production of the gas 24 is performed within the plasma of an electric arc 18 submerged in a feedstock 22. The electric arc 18 is formed by providing a flow of electrical current between an anode 14 and a cathode 16 that are of sufficient proximity to each other as to allow arcing between the anode 14 and the cathode 16. A power supply 10 provides sufficient power (voltage and current) as to initiate and maintain the electric arc 18.

A feedstock 22 is circulated within a pressure reactor 12 by, for example, a circulation pump 50. The feedstock 22 is injected into the plasma of the electric arc 18 formed between the two electrodes 14/16, causing the feedstock 22 to react, depending upon the composition of the feedstock 22 and the composition of the electrodes 14/16 used to create the arc. One feedstock 22 is, for example, oil, and more particularly, used vegetable or animal oil such as that from deep-fat fryers, etc. Of course, any oil is anticipated, including unused vegetable oil and oil from animal fat.

Any feedstock 22 is anticipated either in fluid form or a fluid mixed with solids, preferably fine-grain solids such as carbon dust, etc.

In one example, the feedstock 22 is vegetable oil and the electrodes 14/16 are carbon, the vegetable oil molecules separate within the plasma of the electric arc 18 forming the gas 24, typically including hydrogen (H₂) and carbon monoxide (CO) atoms, which percolate to the surface of the feedstock 22 for collection (e.g. extracted through a collection pipe 26) and stored in a collection tank 30. This gas 24 is similar to synthetic natural gas or syngas, but the gas produced though this process behaves differently and produces a higher temperature burn. In embodiments in which at least one of the electrodes 14/16 that form the electric arc 18 is made from carbon, such electrode(s) 14/16 serve as a source of charged carbon particles that become suspended within the gas 24 and are collected along with the gas 24, thereby further improving the burning properties of the resulting gas 24.

In examples in which the feedstock 22 is a petroleum-based liquid, the exposure of this feedstock 22 to the plasma of the electric arc 18 results in production of a gas that includes polycyclic aromatic hydrocarbons which, in some embodiments, are quasi-nanoparticles that are not stable and, therefore, some of the polycyclic aromatic hydrocarbons will form/join to become nanoparticles or a liquid. Therefore, some polycyclic aromatic hydrocarbons as well as some carbon particles will be present in the gas 24. In some embodiments, some of the carbon particles are trapped or enclosed in poly cyclic bonds. Analysis of the gas 24, as produced in this example, typically shows inclusion of polycyclic aromatic hydrocarbons that range from C6 to C14. The presence of polycyclic aromatic hydrocarbons as well as carbon particles contributes to the unique burn properties of the gas 24 that is produced. The gas 24 that is produced has higher burning temperatures.

In another example, when the feedstock 22 is petroleum based (e.g. used motor oil) and at least one of the electrodes 14/16 is/are carbon, the petroleum molecules separate within the plasma of the electric arc 18 into a gas 24 that includes hydrogen (H₂) and aromatic hydrocarbons, which percolate to the surface of the feedstock 22 (e.g. petroleum liquid) for collection (e.g. extracted through a collection pipe 26) and stored in a collection tank 30. In some embodiments, the gas 24 produced though this process includes suspended carbon particles since at least one of the electrodes of the electric arc 18 is made from carbon and serves as the source for the charged carbon particles that travel with the gas 24 (including hydrogen and aromatic hydrocarbon) and are collected along with, for example, the hydrogen and aromatic hydrocarbon molecules, thereby the gas 24 produced as describe burns with a hotter flame temperature. In this example, if the feedstock 22 is oil (e.g. used oil) and the fluid/gas 24 collected includes any or all of the following: hydrogen, ethylene, ethane, methane, acetylene, and other combustible gases to a lesser extent, plus suspended charged carbon particles that travel with the gas 24.

In another example, when the feedstock 22 is water based (e.g. sewerage or waste water) the water molecules separate within the plasma of the electric arc 18 into a gas 24 that includes hydrogen (H₂), which percolates to the surface of the feedstock 22 for collection (e.g. extracted through a collection pipe 26) and stored in a collection tank 30. In some embodiments, the gas 24 produced though this process includes suspended carbon particles since at least one of the electrodes 14/16 is made from carbon and serves as the source for the charged carbon particles that travel with the gas 24 and are collected along with, for example, the hydrogen molecules, thereby changing the burning properties of the gas 24 to produce a hotter flame temperature when burned.

The resulting gas is stored in, for example, a collection tank 30 and moved/distributed as known in the gaseous/liquid fuel industry.

In the example shown in FIG. 1, a circulation pump 50 flows the feedstock 22 through the plasma of the electric arc 18 formed between the electrodes 14/16. In such, manual adjustment of the arc, power, and refilling of the feedstock are performed.

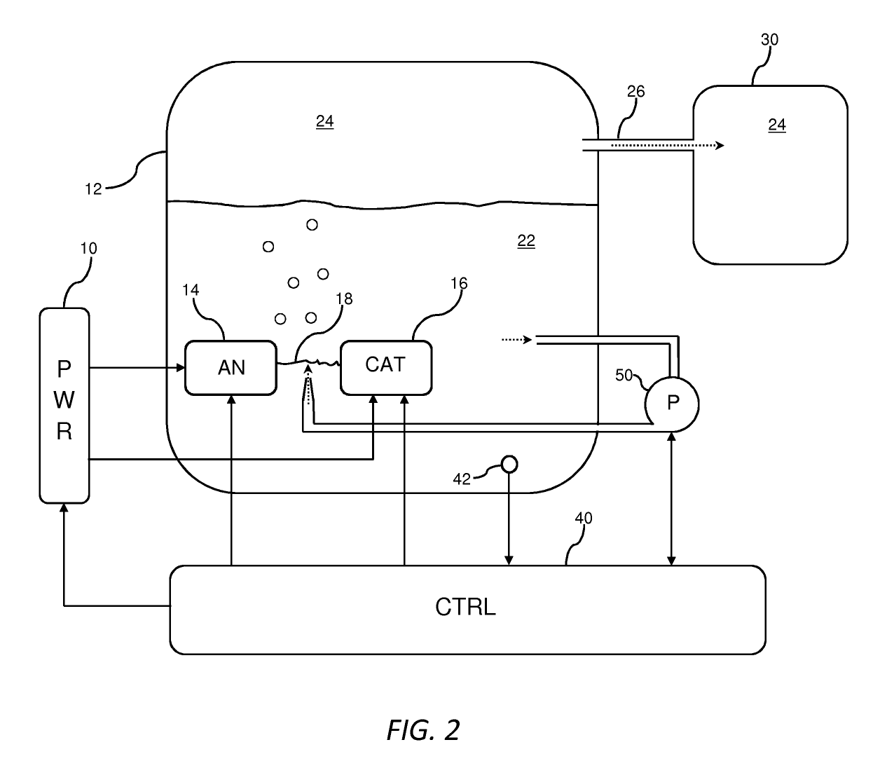

In the example shown in FIG. 2, the circulation pump 50, the power supply, and/or the electrodes 14/16 are controlled by a control system 40, typically a computer-based controller. The control system 40 monitors the performance of the electric arc 18, controlling the current flowing through the electric arc 18 by the power supply 10, moving the anode 14 and/or cathode 16 closer to each other or farther away from each other to adjust the resulting plasma of the electric arc 18, cycling the electrodes 14/16 as one or both electrodes 14/16 erode due to the electric arc 18, and adjusting speed of the circulation pump 50 and, therefore, flow rate through the plasma of the electric arc 18.

As some of the feedstock 22 is transformed into the gas 24, the feedstock 22 that remains becomes more viscous, especially when impurities are suspended in the feedstock 22. One example of such is a feedstock 22 of used motor oil. As the viscosity of the feedstock 22 increases due to higher concentrations of, for example, fine metal particles, it takes more work for the circulation pump 50 to maintain the same flow rate through the plasma of the electric arc 18. In some embodiments, the load of a motor driving the circulation pump 50 is measured, which will correlate the viscosity of the feedstock 22 being pumped. As the load of the motor increases, the control system 40 increases power to the circulation pump 50 to maintain a certain level of flow, for example, a constant flow rate. In other embodiments, a viscosity sensor 42 provides a signal to the control system 40, informing the control system 40 of the current viscosity of the feedstock 22 and the control system 40 adjusts the pump speed to compensate for the measured viscosity. At some point, the measured viscosity or the load of the motor driving the circulation pump 50 exceeds a pre-determined level, the control system 40 indicates such to an operator for stopping, cleaning, and/or refilling the system. The viscosity sensor 42 is any sensor known anticipated for use in this application.

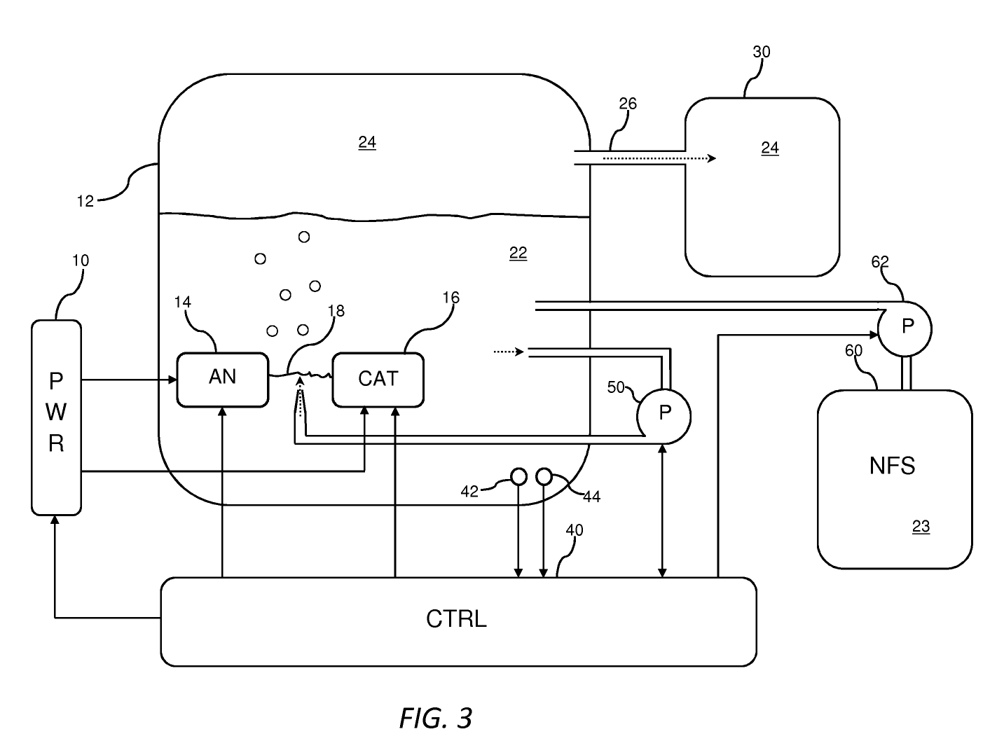

In the example shown in FIG. 3, a feedstock replenishment pump 62 and a feedstock replenishment tank 60 containing fresh feedstock 23 is included to the example of FIG. 2. In this, the circulation pump 50, the power supply 10, the feedstock replenishment pump 62, and/or the electrodes 14/16 are controlled by the control system 40. The control system 40 monitors the performance of the electric arc 18, controlling the current flowing through the electric arc 18 by the power supply 10, moving the anode 14 and/or cathode 16 closer to each other or farther away from each other to adjust the resulting plasma of the electric arc 18, cycling the electrodes 14/16 as one or both electrodes erode due to the electric arc 18, and adjusting the speed of the circulation pump 50 and, therefore, flow rate through the plasma of the electric arc 18. The control system 40 also controls the feedstock replenishment pump 62, signaling the feedstock replenishment pump 62 to pump additional feedstock 22 from a feedstock replenishment tank 60 containing additional feedstock 22.

As some types of feedstock 22 are transformed into the gas 24, the feedstock 22 remaining in the pressure reactor 12 becomes more viscous, especially when impurities are suspended in the feedstock. One example of such is used motor oil, as the oil content is converted to gas 24 by the plasma of the electric arc 18, the remaining feedstock 22 (oil) becomes more concentrated with, for example, suspended fine-grain metal particles. As the viscosity of the feedstock 22 increases, it takes more work for the circulation pump 50 to maintain the same flow rate through the plasma of the electric arc 18. In some embodiments, the load of a motor driving the circulation pump 50 is measured, which will correlate the viscosity of the feedstock 22 being pumped. In some embodiments, a viscosity sensor 42 provides a signal to the control system 40, informing the control system 40 of the current viscosity of the feedstock 22. When the control system 40 finds the viscosity to be too high, the control system 40 either adjusts the speed of the circulation pump 50 to compensate for the high viscosity or initiates operation of the feedstock replenishment pump 62 for a specific period of time to further dilute the feedstock 22 within the pressure reactor 12 with fresh feedstock 23 from the feedstock replenishment tank 60. In some systems the control system 40 does both, adjusting the pump speed to compensate for the high viscosity and initiating operation of the feedstock replenishment pump 62 to insert a certain amount of fresh feedstock 23. In some embodiments, the feedstock replenishment pump 62 is operated for a specific period of time or until the measured viscosity lowers to a predetermined level. It is anticipated that various level and pressure sensors are used to make sure that the pressure reactor 12 is not overfilled, etc.

It is also anticipated that, at some point in the operation, the measured viscosity exceeds a pre-determined level and the control system 40 indicates such to an operator for stopping, flushing, cleaning, and/or refilling the system.

In this same example, as some types of feedstock 22 are transformed into the gas 24, the conductivity of these feedstocks 22 changes due to certain dissolved or suspended materials concentrating in the feedstock 22 remaining within the pressure reactor 12. One example of such is water containing salts. It is known that pure water does not conduct electricity (e.g. distilled water), but as salts are added to this pure water, water with suspended salts now conducts electricity. If the concentration of salts in the feedstock 22 within the pressure reactor 12 increases to a certain level, operation of the electric arc 18 will be affected. Likewise, in examples where the feedstock 22 is used motor oil, as the concentration of fine-grain particles of metal in the used motor oil increases, so does the conductivity of the feedstock 22.

As the conductivity of the feedstock 22 within the pressure reactor 12 increases, operation of the electric arc 18 is affected. In some embodiments, the load (current flow) of the electric arc 18 on the power supply 10 is measured, which will correlate the conductivity of the feedstock 22 being pumped through the plasma of the electric arc 18 as well as the distance between the electrodes 14/16. In some embodiments, a conductivity sensor 44 provides a signal to the control system 40, informing the control system 40 of the present conductivity of the feedstock 22. When the control system 40 finds the conductivity to be too high, the control system 40 either changes position of the electrodes 14/16 and/or initiates operation of the feedstock replenishment pump 62 for a specific period of time to further dilute the feedstock 22 within pressure the reactor 12 with fresh feedstock 23. In some embodiments, the feedstock replenishment pump 62 is operated for a specific period of time or until the measured conductivity lowers to a predetermined level. It is anticipated that various level and pressure sensors are used to make sure that the pressure reactor 12 is not overfilled, etc.

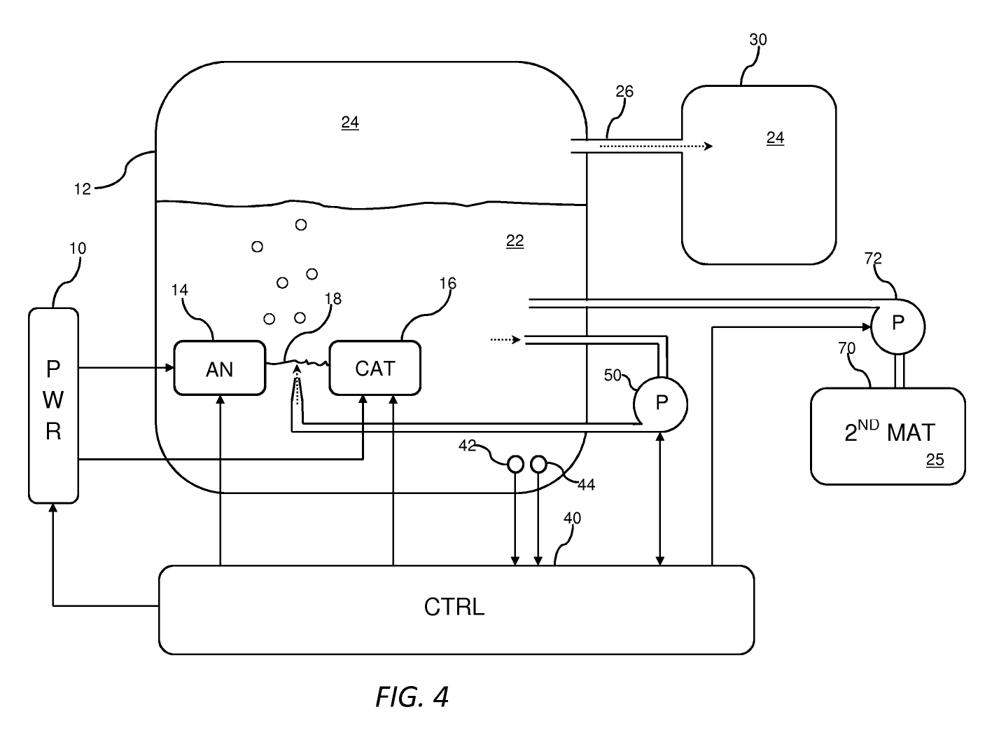

Referring now to FIG. 4, a similar system to that described in FIG. 3 but instead of a feedstock replenishment pump 62 and a source of fresh feedstock 23, a secondary material tank 70 and secondary material pump 72 is included. In this, the circulation pump 50, the power supply 10, the secondary material pump 72, and/or the electrodes 14/16 are controlled by the control system 40. Again, the control system 40 monitors the performance of the electric arc 18, controlling the current flowing through the arc by the power supply 10, moving the anode 14 and/or cathode 16 closer to each other or farther away from each other to adjust the resulting plasma of the electric arc 18, cycling the electrodes 14/16 as one or both electrodes erode due to the electric arc 18, and adjusting the speed of the circulation pump 50 and, therefore, flow rate through the plasma of the electric arc 18. The control system 40 also controls the secondary material pump 72, signaling the secondary material pump 72 to pump a quantity of a secondary material 25 from a secondary material tank 70 that contains this secondary material 25. Any secondary material 25 is anticipated. Examples of secondary materials 25 include, but are not limited to, distilled water, tap water, petroleum-based solvents, alcohol, turpentine, etc.

As some types of feedstock 22 are transformed into the gas 24, the remaining feedstock 22 becomes more viscous, especially when impurities are suspended in the feedstock 22. One example of such is used motor oil, as the oil content is converted to gas 24 by the plasma of the electric arc 18, the remaining feedstock 22 (oil) becomes more concentrated, for example, with suspended fine-grain metal particles. As the viscosity of the feedstock 22 increases, it takes more work for the circulation pump 50 to maintain the same flow rate through the plasma of the electric arc 18. In some embodiments, the load of the motor that drives the circulation pump 50 is measured, which correlates the viscosity of the feedstock 22 being pumped. In some embodiments, a viscosity sensor 42 provides a signal to the control system 40, informing the control system 40 of the current viscosity of the feedstock 22. When the control system 40 finds the viscosity to be too high, the control system 40 either adjusts the speed of the circulation pump 50 to compensate for the high viscosity or initiates operation of the secondary material pump 72 for a specific period of time to further dilute the feedstock 22 within the pressure reactor 12 with the secondary material 25 from the secondary material tank 70. In some systems the control system 40 does both, adjusting the pump speed to compensate for the high viscosity, and initiating operation of the secondary material pump 72 to insert a certain amount of the secondary material 25. In some embodiments, the secondary material pump 72 is operated for a specific period of time or until the measured viscosity lowers to a predetermined level. It is anticipated that various level and pressure sensors are used to make sure that the pressure reactor 12 is not overfilled, etc. In the example with used motor oil as the feedstock 22, a secondary material 25 such as a solvent will dilute the used motor oil, either reducing the viscosity of the used motor oil, reducing the conductance of the used motor oil, or both.

It is also anticipated that, at some point in the operation, the measured viscosity exceeds a pre-determined level and the control system 40 indicates such to an operator for stopping, flushing, cleaning, and/or refilling the system.

As some types of feedstock 22 are transformed into the gas 24, the conductivity of these feedstocks changes due to certain dissolved or suspended materials concentrating in the remaining feedstock 22. One example of such is water containing salts. It is known that pure water does not conduct electricity (e.g. distilled water), but as salts are added to this pure water, water with suspended salts now conducts electricity. If the concentration of salts in the feedstock 22 within the pressure reactor 12 increases to a certain level, operation of the electric arc 18 will be affected.

Over time, the conductivity of the feedstock 22 within the pressure reactor 12 increases and operation of the electric arc 18 is affected. In some embodiments, the load of the electric arc 18 on the power supply 10 is measured, which will correlate the conductivity of the feedstock 22 being pumped through the plasma of the electric arc 18 as well as the distance between the electrodes 14/16. In some embodiments, a conductivity sensor 44 provides a signal to the control system 40, informing the control system 40 of the present conductivity of the feedstock 22. When the control system 40 finds the conductivity to be too high, the control system 40 either changes position of the electrodes 14/16 and/or initiates operation of the secondary material pump 72 for a specific period of time to further dilute the feedstock 22 within the pressure reactor 12 with the secondary material 25. In some embodiments, the secondary material pump 72 is operated for a specific period of time or until the measured conductivity lowers to a predetermined level. In the example of a feedstock 22 of salts dissolved in water, as the water molecules are converted into the gas 24, the salt content of the remaining feedstock 22 increases, as does the viscosity and/or conductivity of the remaining feedstock 22. In this example, when the control system 40 determines that the viscosity and/or conductivity exceeds a predetermined threshold, the secondary material pump 72 is activated for a period of time or until the viscosity and/or conductivity decrease to a lower predetermined threshold. In this example, the secondary material 25 is preferably distilled water, tap water, or pure water, having lower amounts of salts (e.g. tap water).

It is anticipated that various level and pressure sensors are used to make sure that the pressure reactor 12 is not overfilled, etc. It is also anticipated that, in some embodiments, any combination of pumps 62/72 are present with any combination of additional fresh feedstock 23 and one or more secondary material(s) 25. For example, in one embodiment, a feedstock replenishment pump 62 adds more fresh feedstock 23 (e.g. raw sewerage) and a secondary material pump 72 adds more secondary material 25 (e.g. fresh water). In another example, one secondary material pump 72 adds more of a first secondary material 25 (e.g. fresh water) and another secondary material pump 72 adds more of a different secondary material 25 (e.g. distilled water). Any number and combination of pumps 62/72, feedstock replenishment tank 60, and secondary material tanks 70 are anticipated. It is also anticipated that, for certain sources of fresh feedstock 23 and secondary material 25, the fresh feedstock 23 and/or secondary material 25 are not stored in tanks 60/70 and, instead, are fed directly from sources of such materials, for example, directly from sewerage lines, water lines, dredge systems, ocean water pumps, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for producing a gas, the system comprising:
a pressure vessel containing in its interior a feedstock and at least one set of electrodes;
an electric arc formed between the electrodes, the electric arc formed within the feedstock;
means for flowing of the feedstock through a plasma of the electric arc thereby converting at least some of the feedstock into the gas;
means for controlling the electric arc;
means for collecting the gas;
means for determining at least one of a conductance of the feedstock and a viscosity of the feedstock; and
means for introducing a material into the pressure vessel based upon the conductance of the feedstock and/or the viscosity of the feedstock.

2. The system for producing the gas of claim 1, wherein the material is fresh feedstock.

3. The system for producing the gas of claim 1, wherein the material is a solvent.

4. The system for producing the gas of claim 1, wherein the material is tap water.

5. The system for producing the gas of claim 1, wherein the material is distilled water.

6. The system for producing the gas of claim 1, wherein the means for flowing of the feedstock is a circulation pump and the viscosity of the feedstock is measured by measuring a load on a motor driving the circulation pump.

7. A system for producing a gas, the system comprising:
a pressure vessel containing in its interior a feedstock and at least one set of electrodes;
a power supply electrically interfaced to the at least one set of electrodes such that an electric arc is formed between the electrodes, the electric arc is submerged within the feedstock;
a circulation pump circulates the feedstock through a plasma of the electric arc where at least some of the feedstock is converted into the gas;
a controller is interfaced to the power supply and controls an amount of the current provided to the electric arc;
the controller determines a viscosity of the feedstock by measuring a load on a motor driving the circulation pump; and
the controller introducing a material into the pressure vessel based upon the viscosity of the feedstock.

8. The system for producing the gas of claim 7, wherein the material is fresh feedstock.

9. The system for producing the gas of claim 7, wherein the feedstock is oil and the material includes a solvent.

10. The system for producing the gas of claim 7, wherein the feedstock is water-based and the material is tap water.

11. The system for producing the gas of claim 7, wherein the feedstock is water-based and the material is distilled water.

12. The system for producing the gas of claim 7, wherein the controller increases an amount of power provided to the motor proportional to increases in the viscosity of the feedstock.

13. A method for producing a gas, the method comprising:
containing a feedstock in a pressure vessel, the pressure vessel having a set of electrodes submerged in the feedstock;
controlling power interfaced to the electrodes, thereby forming an electric arc between the electrodes, the electric arc also submerged within the feedstock;
circulating the feedstock through a plasma of the electric arc, thereby converting at least some of the feedstock into the gas;
determining a viscosity of the feedstock; and
introducing a material into the pressure vessel based upon the viscosity of the feedstock.

14. The method for producing the gas of claim 13, wherein the material is fresh feedstock.

15. The method for producing the gas of claim 13, wherein the feedstock is oil and the material includes a solvent.

16. The method for producing the gas of claim 13, wherein the feedstock is water-based and the material is tap water.

17. The method for producing the gas of claim 13, wherein the feedstock is water-based the material is distilled water.

18. The method for producing the gas of claim 13, further comprising a step of increasing an amount of power provided to the motor proportional to increases in the viscosity of the feedstock.

19. The method for producing the gas of claim 13, wherein the step of determining the viscosity of the feedstock includes measuring an amount of current consumed by the step of circulating.

20. The method for producing the gas of claim 13, wherein the step of determining the viscosity of the feedstock includes measuring a value from a viscosity sensor.
